(19) United States
(12) Patent Application Publication
(10) Pub. No.: US 2016/0039400 A1
(43) Pub. Date: Feb. 11, 2016

(54) MULTI-PASSAGEWAY ASPIRATOR

(71) Applicant: FORD GLOBAL TECHNOLOGIES, LLC, DEARBORN, MI (US)

(72) Inventor: XIAOGANG ZHANG, NOVI, MI (US)

(21) Appl. No.: 14/454,953

(22) Filed: Aug. 8, 2014

(51) Int. Cl. B60T 13/46; B60R 16/08

(52) U.S. Cl. CPC B60T 13/46; B60R 16/08

(57) ABSTRACT

In one or more embodiments, an aspirator of a vehicle includes a body portion with an inlet and an outlet, and an arm portion connected to the body portion at a location between the inlet and the outlet, wherein a cross-section of the inlet includes an inner wall and an outer wall enclosing the inner wall. The outer wall may be spaced apart from the inner wall along an outer perimeter of the inner wall. The inner and outer walls may be concentric to each other.

### TECHNICAL FIELD

The disclosed inventive concept relates generally to a multi-passageway aspirator that may be used in vehicular applications to create and maintain a vacuum environment.

### BACKGROUND

Certain vehicles may use intake manifold vacuum to provide brake boost or power assist. In line with these designs, an aspirator may be used to create and/or maintain a level of vacuum needed for the brake boost. Certain existing aspirators have been met with limitations by, for instance, requiring a separate flow bypass with additional valve controls, the design and use of which likely being labor intensive and cost inefficient.

### SUMMARY

In one or more embodiments, an aspirator of a vehicle includes a body portion with an inlet and an outlet, and an arm portion connected to the body portion at a location between the inlet and the outlet, wherein a cross-section of the inlet includes an inner wall and an outer wall enclosing the inner wall. The outer wall may be spaced apart from the inner wall along an outer perimeter of the inner wall.

The inner and outer walls may respectively define inner and outer passageways along a first longitudinal axis of the body portion. The arm portion may include an arm passageway along a second longitudinal axis of the arm portion.

Two of the inner, outer and arm passageways may be for communication with a first fluid source and the other for communication with a second fluid source different from the first fluid source. In particular, the inner and arm passageways may be for communication with the first fluid source and the outer passageway for communication with the second fluid source.

The inner and outer walls may be of different cross-sectional shapes.

The cross-section of the inlet may further include an exterior wall enclosing the outer wall, the exterior wall and the outer wall together defining an exterior opening.

The aspirator may further include a valve in communication with any one of the inner, outer and arm passageways.

One or more advantageous features as described herein will be readily apparent from the following detailed description of one or more embodiments when taken in connection with the accompanying drawings.

### BRIEF DESCRIPTION OF THE DRAWINGS

For a more complete understanding of one or more embodiments of the present invention, reference is now made to the one or more embodiments illustrated in greater detail in the accompanying drawings and described below wherein:

FIG. 1 illustratively depicts an aspirator as may be employed in connection with a vacuum reservoir and an engine intake manifold, according to one or more embodiments;

FIG. 2 illustratively depicts an enlarged view of the aspirator referenced in FIG. 1;

FIG. 3 illustratively depicts a cross-sectional view of the aspirator referenced in FIG. 1;

FIG. 4A illustratively depicts an alternative view of the aspirator referenced in FIG. 1;

FIG. 4B illustratively depicts a cross-sectional view of the aspirator referenced in FIG. 4A; and

FIG. 5 shows performance data on a sample aspirator according to one or more embodiments.

### DETAILED DESCRIPTION OF ONE OR MORE EMBODIMENTS

As referenced in the FIG.s, the same reference numerals are used to refer to the same components. In the following description, various operating parameters and components are described for different constructed embodiments. These specific parameters and components are included as examples and are not meant to be limiting.

The disclosed inventive concept is directed to an aspirator system that may be positioned between a vacuum reservoir and an engine intake manifold for extracting unwanted air from the vacuum reservoir. By providing separate and additional fluid passageway(s) within a body portion and eliminating the need for any bypass fluid passageway(s) external to the body portion, the inventive concept in one or more embodiments is believed to be advantageous in providing cost efficiency and reducing technical complexity. In addition, and because now the fluid from different flow passageways may be mixed within the body portion relatively earlier in time and more thorough along a longitudinal axis of the body portion, enhanced performance may also be expected.

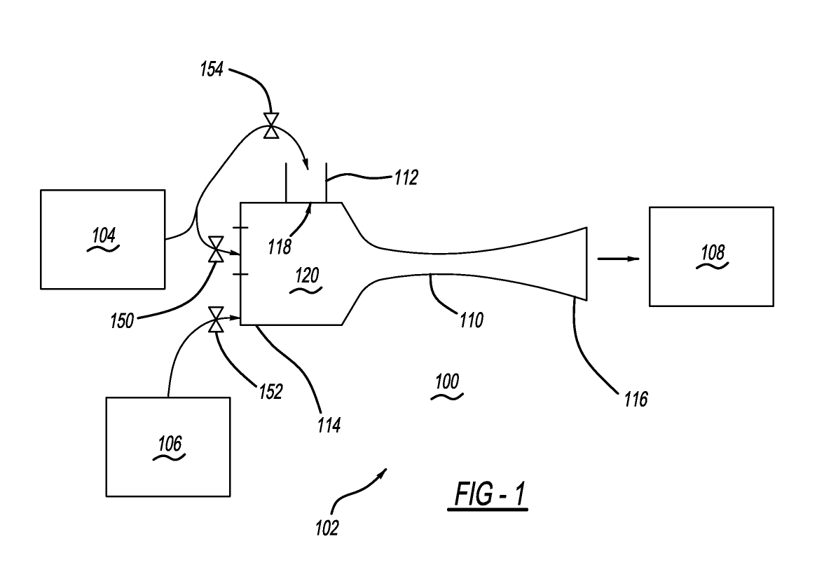

In one or more embodiments, and in view of FIG. 1, an aspirator system generally shown at 102 includes an aspirator 100 positioned between a vacuum reservoir 104 and an engine intake manifold 108. The aspirator system 102 also includes an air source 106 positioned upstream of the aspirator 100 to drive fluid flow from the vacuum reservoir 104 via the aspirator 100. Two flow inlets may both be connected to the vacuum reservoir 104 as shown in FIG. 1; alternatively, one flow inlet is connected to the vacuum reservoir 104 and the other to a positive crankcase ventilation (PCV).

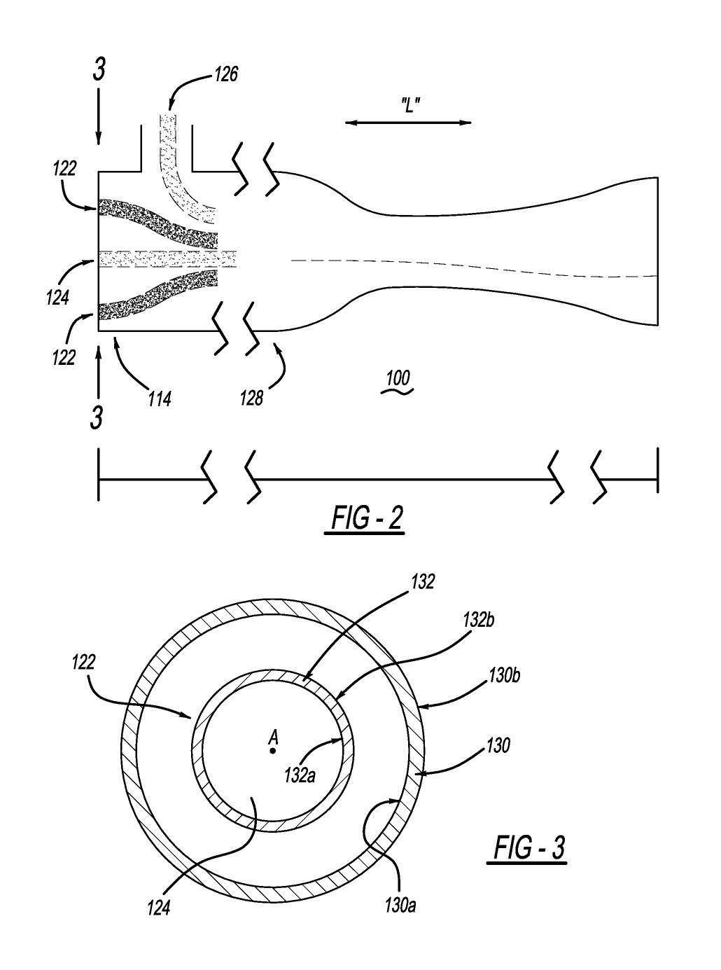

Referring back to FIG. 1, and further in view of FIG. 2 which presents a more detailed view of the aspirator 100 referenced in FIG. 1, the aspirator 100 includes a body portion 110 with an inlet 114 and an outlet 116. The body portion 110 includes an inner passageway 124 and an outer passageway 122 each extending along a longitudinal axis “L” of the body portion 110 for carrying out a fluid flow. At a position downstream of the inlet 114, an arm passageway 126 is provided via an arm portion 112 for introducing another fluid flow. In certain embodiments, the fluid flows passing through the passageways 124 and 126 may be referred to as suck flows, and the fluid flow passing through the passageway 122 may be referred to as a motive flow. Streams of fluids from the passageways 122, 124 and 126 get mixed at a mixing portion 128 of the aspirator 100 to produce a mixed fluid stream which then gets transported out to a downstream device such as the engine intake manifold 108.

FIG. 3 illustratively depicts a cross-section of the inlet 114 of the aspirator 100. The inner passageway 124 is defined by an inner wall 132. The outer passageway 122 is defined by an outer wall 130 and the inner wall 132. As shown in FIG. 3, the outer wall 130 is spaced apart from the inner wall 132 along an outer perimeter 132b of the inner wall 132. To fully retain a fluid flow, at least one of the inner and outer perimeters 132a, 132b of the inner wall 132 is a closed loop. For the same token, at least one of inner and outer perimeters 130a, 130b of the outer wall 130 is also a closed loop.

To meet certain particular requirement in flow dynamics, it is optional that the inner passageway 124 is divided into any suitable number of compartments with any suitable types of shapes. For the same token, it is optional that the outer passageway 122 is divided into any suitable number of compartments with any suitable types of shapes.

Referring back to FIG. 1, flow entry at the inlet 114 of the body portion 110 and an inlet 118 of the arm portion 112 may be controlled independently via a valve. For instance, a flow from the vacuum reservoir 104 via the inner passageway 124 may be controlled via a valve 150. A flow from the vacuum reservoir 104 via the arm passageway 126 may be controlled via a valve 154. A flow from the air source 106 via the outer passageway 122 may be controlled via a valve 152.

It is not necessary that the inner passageway 124 and the arm passageway 126 are for fluid communication with the vacuum reservoir 104 and the outer passageway 122 is for fluid communication with the air source 106. Rather, each of the passageways 122, 124 and 126 may be positioned for intaking any of the fluid flows, as long as a fluid flow from either source 104, 106 is taken in via at least one of the passageways 122, 124, 126. In certain embodiments, the passageway 122 may be employed as the air source, and the passageways 124 and 126 each as the vacuum source. Optionally, each of the passageways 122, 124 and 126 may be connected an air source providing a drive force or a vacuum source.

Referring back to FIG. 1, the vacuum reservoir 104 is one of the example structures of a first fluid source that may be in connection and provide fluid flow to the aspirator 100. Other example structures of the first fluid source include a crankcase. For the same token, the air source 106 is one of the example structures of a second fluid source that may be in connection with and provide fluid flow to the aspirator 100. Other example structures of the second fluid source include ambient air or compressed air downstream of a compressor.

Referring back to FIG. 2 and FIG. 3, the inner passageway 124 and the outer passageways 122 are optionally of the same or different cross-sectional shapes. Non-limiting examples of the cross-sectional shapes include round, oval, square, rectangle, triangle, and other geometrical shapes. When being different from each other, the inner passageway 124 may be of a shape of a circle and the outer passageway 122 may be of a shape of an oval. Without wanting to be limited to any particular theory, it is believed that the outer passageway 122 as defined by the shapes of the outer and inner walls 130, 132 may impact the flow dynamics of the fluid flow passing there-through and also the merging pattern of all the fluid flows coming into each other. Accordingly, being able to accommodate different cross-sectional shapes for passageways formed within the body portion 110, the aspirator 100 provides relatively widened design windows for various flow and efficiency parameters.

Referring back to FIG. 3, the inner and outer walls 132, 130 may be concentric to each other relative to a center point “A”, whether or not the walls 132, 130 are of the same geometrical shapes. Non-limiting examples of these pairing arrangements include concentric circles, concentric circle and square pair, concentric circle and triangle pair, concentric rectangles or squares, and concentric triangles.

In addition, a ratio of an inner area defined by the inner wall and an outer area defined by the inner and outer walls may be of any suitable values, and in some embodiments is 1:1.5 to 1:2.0.

Referring back to FIG. 2 and in view of FIG. 3, a flow stream coming through the arm passageway 126 may at least partially first hit an outer surface 130b of the outer wall 130. All flow streams from the passageways 122, 124 and 126 may come in contact with each other at a neck area 128 downstream of the arm portion 112 and get mixed together there and thereafter. Without wanting to be limited to any particular theory, it is believed that permitting the fluid stream to directly contact the outer surface 130b effectively changes the flow direction, for instance, from a perpendicular direction to a horizontal or parallel direction, which accordingly increases the sucking flow rate through the passageways 124, 126. In addition, by creating for the three flow streams to meet or mix at the neck area 128 a relatively lower static pressure may be generated at this region and hence a relatively maximized fluid flow from the passageways 124 and 126.

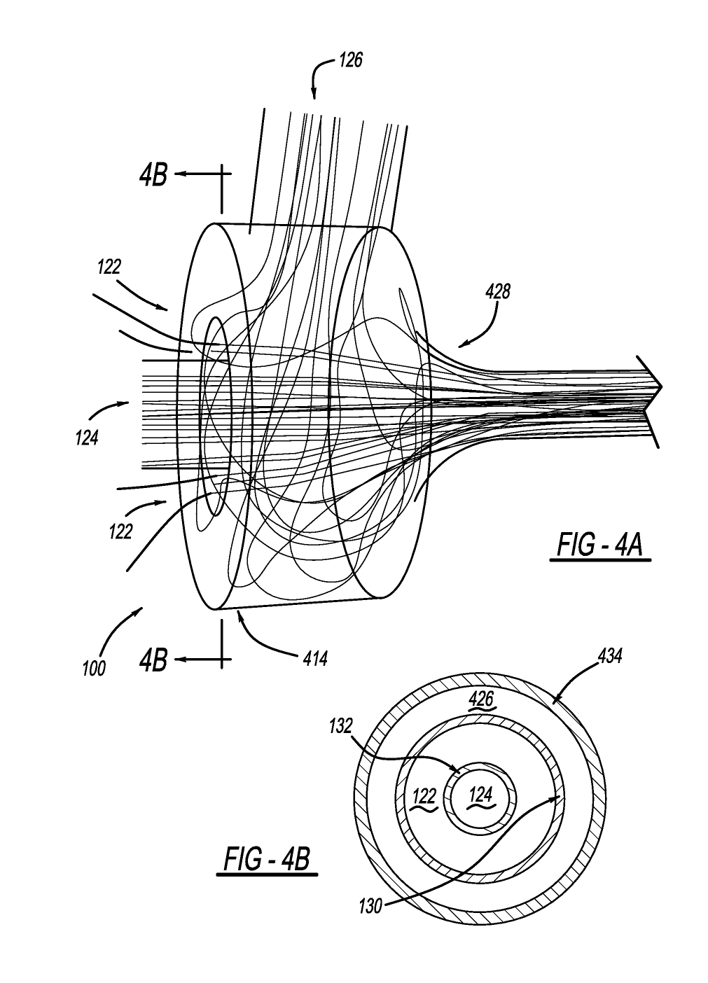

FIG. 4A illustratively depicts a flow diagram of an aspirator with a variation to the aspirator shown in FIG. 3, wherein FIG. 4B illustratively depicts a cross-sectional view of an inlet 414 of the aspirator 100. The cross-section of the inlet 414 according this embodiment includes an external wall 434 in addition and external to the inner and outer walls 132, 130. The outer and external walls 130, 434 together define an external passageway 426 along the longitudinal axis “L” of the body portion 110. Two separate fluid streams are introduced via the inner and outer passageways 124, 122, which are defined by the inner wall 132, and by the inner and outer walls 132, 130, respectively. Another fluid stream is introduced via the arm passageway 126. In this configuration, the arm portion 112 may be connected to the body portion 110 via the exterior wall 434 so as to be in fluid communication with each other. The flow stream via the arm passageway 126 comes through the external passageway 426 and then all the three fluid streams come in contact with one another at the location 402. Even though the three flow streams come together at roughly the same area such as a neck area 428, the relative locations may vary and be determined by computational fluid dynamics (CFD) simulations. One possible way of achieving this is to maximize flow rate from the brake tank, wherein the flow stream from the brake tank needs to be introduced at a location with the lowest possible static pressure.

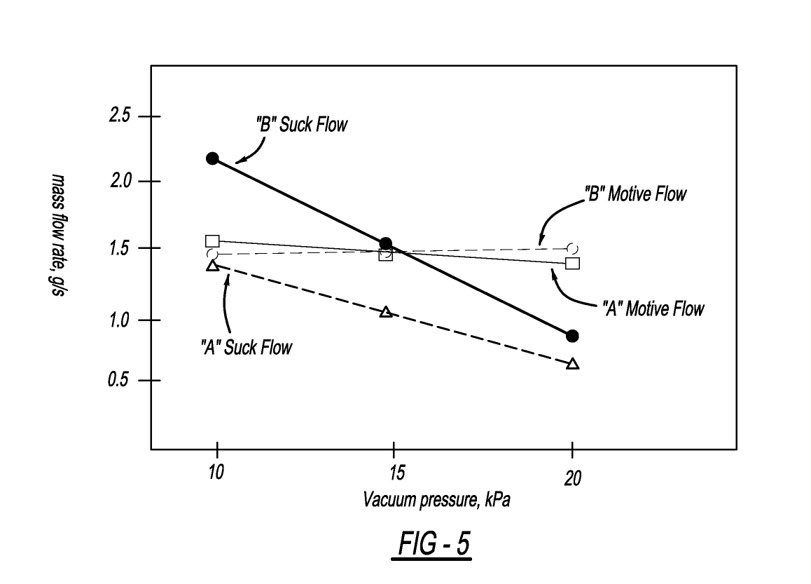

FIG. 5 shows fluid or mass flow rate as a function of vacuum pressure measured from a sample aspirator such as the aspirator 100 shown in FIG. 1. In this example, CFD simulations are is used wherein both flow passageways 124 and 126 are connected to a brake vacuum tank to conduct the suck flows and the flow passageway 122 is open to ambient air at around 100 kPa pressure to conduct the motive flow. The brake vacuum tank pressure is kept at around 85 kPa while mass flow rates are calculated at all three flow inlets as outlet (manifold) pressure decreases from 90 kPa to 60 kPa (manifold vacuum pressure increases from 10 to 40 kPa, as shown in the horizontal axial in FIG. 5). Employed as a comparative control is a similar aspirator while the inner passageway 124 is instead placed external to the body portion 110.

Numerical results are shown in FIG. 5 where letter “A” refers to results directed to the comparative control and letter “B” refers to results directed to the design according to FIG. 1. As can be seen from FIG. 5, while motive flow for either design stays relatively unchanged from each other, the suck flow rate experiences a sizable change between the two designs. In particular, relatively improved suck flow rate is observed with the design according to FIG. 1 or its suitable variations discussed herein in direct comparison to the control. The improvement in the suck flow is particularly observed with the vacuum pressure being at about 10 to 23 kPa in this example. This improvement makes it possible to remove a flow bypass associated with an expensive control valve under engine idle condition where vacuum pressure is relative low such as being in a range of 10 to 23 kPa shown in FIG. 5.

In one or more embodiments, the present invention as set forth herein is believed to have overcome certain challenges associated with aspiration efficiencies. However, one skilled in the art will readily recognize from such discussion, and from the accompanying drawings and claims that various changes, modifications and variations can be made therein without departing from the true spirit and fair scope of the invention as defined by the following claims.

What is claimed is:

1. An aspirator of a vehicle, comprising:
a body portion with an inlet and an outlet; and
an arm portion connected to the body portion at a location between the inlet and the outlet, wherein a cross-section of the inlet includes an inner wall and an outer wall enclosing the inner wall.

2. The aspirator of claim 1, wherein the outer wall is spaced apart from the inner wall along an outer perimeter of the inner wall.

3. The aspirator of claim 1, wherein the inner and outer walls are concentric to each other.

4. The aspirator of claim 1, wherein the inner wall defines an inner passageway, the inner and outer walls together define an outer passageway, and the arm portion includes an arm passageway for communication with the body portion.

5. The aspirator of claim 4, wherein two of the inner, outer and arm passageways are for communication with a first fluid source and the other for communication with a second fluid source different from the first fluid source.

6. The aspirator of claim 5, wherein the inner and arm passageways are for communication with the first fluid source and the outer passageway is for communication with the second fluid source.

7. The aspirator of claim 1, wherein the inner and outer walls are of different cross-sectional shapes.

8. The aspirator of claim 1, wherein the cross-section of the inlet further includes an exterior wall enclosing the outer wall, the exterior wall and the outer wall together defining an exterior passageway.

9. The aspirator of claim 4, further comprising a valve in communication with any one of the inner, outer and arm passageways.

10. The aspirator of claim 1, wherein a ratio of an inner area defined by the inner wall and an outer area defined by the inner and outer walls is 1:1.5 to 1:2.0.

11. An aspirator system of a vehicle, comprising:
a vacuum reservoir; and
an aspirator positioned downstream of the vacuum reservoir, the aspirator including a body portion with an inlet and an outlet, and an arm portion connected to the body portion at a location between the inlet and the outlet, wherein a cross-section of the inlet includes an inner wall and an outer wall enclosing the inner wall.

12. The aspirator system of claim 11, further comprising an engine intake manifold positioned downstream of the aspirator.

13. The aspirator system of claim 11, wherein the outer wall is spaced apart from the inner wall along an outer perimeter of the inner wall.

14. The aspirator of claim 11, wherein the inner and outer walls are concentric to each other.

15. The aspirator of claim 11, wherein the inner wall defines an inner passageway, the inner and outer walls together define an outer passageway, and the arm portion includes an arm passageway for communication with the body portion

16. The aspirator of claim 15, wherein two of the inner, outer and arm passageways are for communication with the vacuum reservoir and the other for communication with a second fluid source different from the vacuum reservoir.

17. The aspirator of claim 11, wherein the inner and outer walls are of different cross-sectional shapes.

18. The aspirator of claim 11, wherein the cross-section of the inlet further includes an exterior wall enclosing the outer wall, the exterior wall and the outer wall together defining an exterior opening.

19. An aspirator of a vehicle, comprising:
a body portion with an inlet and an outlet, a cross-section of the inlet including an inner wall, an outer wall enclosing the inner wall and an exterior wall enclosing the outer wall, the inner wall defining an inner passageway, the inner and outer walls together defining an outer passageway, and the outer and exterior walls together defining an exterior passageway; and
an arm portion connected to the body portion at a location between the inlet and the outlet, the arm portion including an arm passageway for communication with the body portion.

20. The aspirator of claim 19, wherein the arm passageway of the arm portion is for fluid communication with the exterior passageway of the body portion.
